(19) United States
(12) Patent Application Publication
(10) Pub. No.: US 2022/0164590 A1
(43) Pub. Date: May 26, 2022

(54) METHODS AND SYSTEMS FOR IDENTIFYING AND AUTHENTICATING PROVENANCE OF WATCHES

(71) Applicant: TruWatch LLC, Delray Beach, FL (US)

(72) Inventors: Christopher John Knowles, London (CA); Matthew A. W. Stepanski, Rumson, NJ (US); Robert Craig Friedman, Hewlett Harbor, NY (US)

(21) Appl. No.: 17/533,023

(22) Filed: Nov. 22, 2021

Related U.S. Application Data
(60) Provisional application No. 63/117,436, filed on Nov. 23, 2020.

(51) Int. Cl. G06K 9/62; G06T 7/20; G06Q 30/00; G04D 7/00

(52) U.S. Cl. CPC G06K 9/6201; G06T 7/20; G06T 2207/10016; G06Q 30/018; G04D 7/004; G06K 9/6232

(57) ABSTRACT

Some embodiments of the present disclosure disclose methods and systems for cataloguing provenances of watches and for authenticating watches based on the catalogue. In some embodiments, an image of a face of a watch and a video of a hand of the watch moving across the face of the watch may be obtained. Further, a set of scale-invariant features of the face may be extracted using a feature transformation algorithm. Further, a motion curve tracing the hand of the watch moving across the face of the watch may be extracted using a visual motion tracker. In addition, the physical attributes of the watch may also be obtained. In some embodiments, the feature transformation features, the motion curve and the physical attributes may be stored in a database configured to catalogue the provenance of watches, which can also be used to authenticate watches.

### CROSS-REFERENCE TO RELATED APPLICATIONS

The present application claims priority to and the benefit of the U.S. Provisional Patent Application No. 63/117,436, filed Nov. 23, 2020, titled “Watch Authentication Based on Unique Identifiers,” which is hereby incorporated by reference in its entirety as if fully set forth below and for all applicable purposes.

### FIELD OF THE INVENTION

The present specification generally relates to identifying the authenticity and provenance of watches, and more specifically, to cataloguing and authenticating watches based on physical features or attributes of the watches and analyses of the faces of the watches.

### BACKGROUND

Vintage as well as contemporary watches can command a significant amount of money when sold, and as a result have attracted the attention of counterfeiters. As with other products, the introduction of counterfeited watches in the market for timepieces harms all the legitimate actors involved in the market, including manufacturers, sellers, buyers, auctioneers, etc., to the benefit of counterfeiters that have become ever more adept at producing fake watches that can be difficult to distinguish visually from real or authentic watches. As such, there is a need for mechanisms that facilitate the cataloguing of legitimate watches as well as authenticating the provenance thereof.

### BRIEF DESCRIPTION OF THE DRAWINGS

FIG. 1 is a block diagram of a networked system for cataloguing and authenticating watches according to various aspects of the present disclosure.

FIG. 2 is a schematic diagram illustrating extraction of features of a face of a watch via a feature transform algorithm, according to various aspects of the present disclosure.

FIG. 3 is a schematic diagram illustrating extraction of motion features of a face of a watch based on a video recording of the same, according to various aspects of the present disclosure.

FIG. 4A is a flowchart illustrating a method of extracting features of a face of a watch, according to various aspects of the present disclosure.

FIG. 4B is a flowchart illustrating a method of cataloguing watches based on their physical attributes, and features of the faces of watches, according to various aspects of the present disclosure.

FIG. 4C is a flowchart illustrating a method of authenticating the provenance of watches based on their physical attributes, and features of the faces of watches, according to various aspects of the present disclosure.

FIG. 5 is an example computer system according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to methods and systems for cataloguing and authenticating watches based on features, such as scale invariant and motion features, of the face of watches, as well as physical features or attributes thereof. In some embodiments, features of a watch can be features of the face of the watch that are extracted via, for instance, the feature transform algorithm discussed in D. G. Lowe, “Distinctive Image Features from Scale-Invariant Keypoints”, International Journal of Computer Vision, V. 60, 91-110 (2004), the disclosure of which is incorporated by reference herein in its entirety. Feature transformation features of the face of a watch can include a set of scale-invariant coordinates that may be generated from a high-resolution high-magnification image of the watch face underneath the watch crystal and generally are not substantially altered by everyday wear and tear. That is, feature transformation features are those features on the face of the watch that are invariant under high-resolution magnification and/or rotation of images of the watch face, and can serve as unique visual fingerprints of watches when extracted using a feature extractor such as but not limited to the above-noted feature transformation algorithm. In some instances, an image of a face of a watch may be progressively magnified, and some or all of features that remain the same or substantially similar during multiple magnifications (e.g., and in some cases rotation) of the images may be classified as feature transformation features of the watch.

In some embodiments, the motion features of a watch can include some or all of the normalized coordinates of the hands on the face of a watch captured by a high speed video recorder recording the motion of the hands, and/or a camera configured to capture images of the face of the watch (e.g., the positions of the hands of the watch) at a high frame rate. The motion of the hands of a watch across the face of the watch may depend on the mechanical systems of the watch that drive the movements of the hands, and as such the curves of the movements (e.g., as calculated from the coordinates of the hands during the movements) can serve as unique mechanical fingerprints of the watch. For example, while a second hand of a watch moving across the watch face from a first mark to a second mark to count a second can appear as a single motion to the naked eye, the movement may in fact include a dampened oscillatory motion where the second hand overshoots and then rings about the second mark before coming to a rest. In such cases, the dampened oscillatory motion of the second hand may trace a motion curve that that can be used as the unique mechanical fingerprints of the watch. In some instances, the motion curve of the hands can be extracted from videos and/or high-frame images of the hands. For example, the coordinates of the hands can be tracked in the images/videos and the motion curve can be extracted or constructed based on the coordinates.

In some embodiments, the physical features of a watch may include physical attributes of a watch that may be used to identify and classify the watch. Examples of such attributes include identifier of the manufacturer, model, brand, serial number, year of manufacture, etc. The attributes may also include any physical features of the watch that may further distinguish the watch from other similar watches, such as but not limited to color, size, shape, band type, etc. It is to be noted that, the physical attributes listed herein are non-limiting and are intended to serve as examples, and that any feature of a watch that may serve to distinguish that watch from any other watch (e.g., in particular any other watch that is similar (e.g., same brand watch)) may be considered as a physical attribute of the watch.

In some embodiments, the scale-invariant features, the motion features, and/or the physical features or attributes of watches that are considered authentic can be assembled to build a catalogue of genuine watches that in turn can be used to authenticate watches of unknown provenance. For example, a database may be used to store watch features data related to watches that are considered to be genuine or authentic, such data including the afore-mentioned scale-invariant features, motion features, and/or physical attributes of the watches. For instance, a provenance service provider or a manufacturer may generate a database by extracting the scale-invariant and motion features of watches that are known or considered to be authentic, gathering the physical attributes of those watches, and saving these features and physical attributes in a database that may be queried to authenticate a watch of unknown provenance. In some embodiments, the phrases related to a watch being considered or known to be “authentic” and “genuine” may refer to an acknowledgement by entities that are responsible for generating or maintaining the database or catalogue that that watch has the provenance claimed thereto (e.g., and as such, the watch may be catalogued in the database by storing the scale-invariant features, motion features, and/or physical attributes of that watch as watch features data or information related to the watch).

In some embodiments, the database of genuine or authentic watches can be used to in turn authenticate a watch of unknown provenance. For example, a person or entity wishing to purchase a candidate watch may wish to determine whether the watch is authentic before purchasing the watch; for instance, whether the candidate watch is one of the watches catalogued in the database of authentic watches. In such cases, a provenance service provider with access to the database may at first obtain the watch features data of the candidate watch: scale-invariant features, motion features, and/or physical attributes of the candidate watch. For instance, as discussed above, the provenance service provider may capture an image of the face of the watch and extract the scale-invariant features of the watch. Further, a video or a high speed or high frame images of the hands of the watch may be recorded to extract the motion curve of one or more hands of the watch. In addition, the physical attributes of the watch may also be obtained (e.g., via visual inspection or obtained from the seller, manufacturer, dealer, etc.). In some instances, the watch features data of the candidate watch, i.e., one or more of the scale-invariant features, motion features, and/or physical attributes of the candidate watch, may then be compared with corresponding watch features data of the watches stored in the database to identify a matching watch. In some embodiments, such a comparison may include generating a match score that is configured to measure or quantify the level of matching between the candidate watch and the watches in the database. In some instances, the watch features data of the candidate watch may be compared with the watch features data in the database of one or more watches to generate corresponding one or more match scores, and the candidate watch may be declared to be an authentic watch when the highest match score of the one or more match scores exceeds a threshold match score. Further, in such cases, the candidate watch may be identified as a match, i.e., to be the same watch as, to the watch with which the candidate watch matched with the highest matching score.

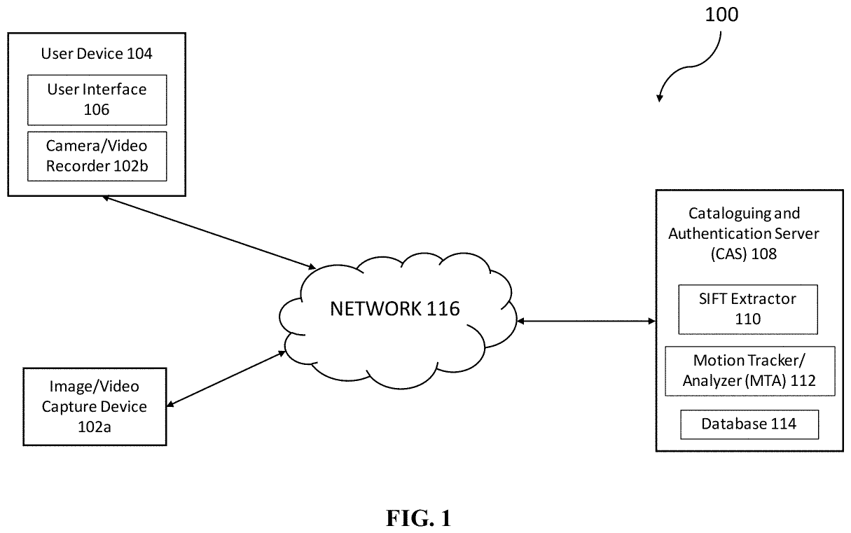

FIG. 1 is a block diagram of a networked cataloguing and authentication (NCA) system 100 for cataloguing and authenticating watches according to an embodiment. The NCA system 100 may comprise or implement a plurality of servers and/or devices that operate to perform various processes of the cataloguing and authentication of watches. The NCA system 100 may include a user device 104, an image/video capture (IVC) device 102a, and a cataloguing and authentication server (CAS) 108 that may be communicatively coupled with each other via a network 116. The user device 104, the IVC device 102a, and the CAS 108 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of NCA system 100, and/or accessible over network 116. Although only one of each user device 104, the IVC device 102a, and the CAS 108 are shown, there can be more than one of each server.

In some embodiments, the network 116 may be implemented as a single network or a combination of multiple networks. For example, in various embodiments, network 116 may include the Internet or one or more intranets, landline networks, wireless networks (e.g., long-term evolution (LTE) wireless network, new radio (NR) fifth generation (5G) network, etc.), and/or other appropriate types of networks. In another example, the network 116 may comprise a wireless telecommunications network (e.g., cellular phone network) adapted to communicate with other communication networks, such as the Internet.

In some embodiments, the user device 104 may include a user interface 106 and/or a camera/video recorder 102b. In some instances, the user interface 106 can be a web browser, an application, etc., which may be utilized by a user of the user device 104 to interact, over the network 116, with the IVC device 102a and/or the CAS 108 to initiate the cataloguing and authentication of watches by the NCA system 100. For example, a user of the user device 104 may utilize the user interface 106 to trigger the camera/video recorder 102b and/or the IVC device 102a to capture images and/or videos of the face of a watch that is being catalogued or authenticated, examples of such images and/or videos including high-magnification images and/or high-speed/high-frame videos of the face of the watch. For instance, the magnification can be in the range from about 300× to about 1000× and the speed or rate of videoing/image capture can be in the range from about 8,000 frames per second to about 16,000 frames per second, including values and subranges therebetween. As another example, the user of the user device 104 may utilize the user interface 106 to provide to the physical attributes of the watch. For instance, the user interface 106 of the user device 104 may be used to input physical attributes of a watch such as but not limited to an identifier of the manufacturer of the watch, the model, the brand, the serial number, the year of manufacture, etc., into the user device 104 for communicating said physical attributes to the CAS 108.

In some implementations, the user interface 106 of the user device 104 can be a graphical user interface (GUI) provided by a software program (e.g., a mobile application) executing therein that allows a user 140 of the user device 104 to interface and communicate with the IVC device 102a and/or the CAS 108 via the network 160. In some implementations, the user interface 106 of the user device 104 can be a network interface (e.g., web browser) provided by a browser module executing therein that allows a user 140 of the user device 104 to interface and communicate with the IVC device 102a and/or the CAS 108 via the network 160. For example, the user interface 106 may be implemented, in part, as a web browser to view information available over the network 116 and communicate with the IVC device 102a and/or the CAS 108.

In some embodiments, the user device 104 may include other applications as may be desired in one or more embodiments of the present disclosure to allow or facilitate the cataloguing and authentication of watches by the NCA system 100. In one example, such other applications may include security applications for implementing client-side security features, programmatic client applications for interfacing with appropriate application programming interfaces (APIs) over the network 116, communication modules for communicating with other device and servers over the network 116, and/or various other types of generally known programs and/or software applications. In some cases, the other applications may interface with the user interface 106 for improved efficiency and convenience.

In some embodiments, the user device 104 may be or be implemented as a personal computer (PC), a cellular phone, a smart phone, a wearable device (e.g., a smart watch), a gaming device, a virtual reality (VR) headset, a laptop computer, a tablet computer (e.g., iPad™ from Apple™), and/or any other type of computing device capable of communicating with remote servers (e.g., CAS 108) via a network (e.g., 116). In some instances, the user device 104 may be equipped with a camera/video module (e.g., software) that controls the camera/video recorder 102b to allow a user of the user device 104 to capture images and/or videos.

In some embodiments, instead of or in addition to the camera/video recorder 102b implemented in the user device 104, the NCA system 100 may include the IVC device 102a. In some instances, the IVC device 102a may be a standalone device having same or similar functionalities as the camera/video recorder 102b of the user device 104. In some instances, the IVC device 102a may be a standalone camera/video device configured to capture images at a magnification ranging from about 300× to about 1000×, and capture a video of the object (e.g., high frame rate capture of images of the object) at a rate ranging from about 8,000 frames per second to about 16,000 frames per second, including values and subranges therebetween. For example, IVC device 102a can be a digital camera (e.g., digital single lens reflex (DSLR) camera), action/adventure camera (e.g., GoPro™), etc., capable of capturing images and videos of the face of the watch at the noted magnification and frame rate, respectively.

In some embodiments, the CAS 108 may be or include a stand-alone and enterprise-class server operating a server OS such as a MICROSOFT™ OS, a UNIX™ OS, a LINUX™ OS, or other suitable server-based OS. It can be appreciated that the CAS 108 may be deployed in other ways and that the operations performed and/or the services provided by such server may be separated for a given implementation and may be performed by a greater number of servers. In such cases, one or more servers may be operated and/or maintained by the same or different entities.

In some embodiments, the CAS 108 may include a feature transformation extractor 110, a motion tracker/analyzer (MTA) 112, and/or a database 114. In some instances, the feature transformation extractor 110 can be a module or application (e.g., software) on the CAS 108 executing a feature transformation algorithm configured to identify features on images that are invariant to size/scale, orientation, translation, viewpoint, pose, and/or at least partially, illumination. That is, in some instances, the feature transformation extractor 110 may be configured to receive an image of a face of a watch from the IVC device 102a or the camera/video recorder 102b, and process the image to extract features that are invariant to scale, orientation, viewpoint, and/or illumination. For example, the feature transformation extractor 110 may be configured to analyze the image to identify features that are invariant to the magnification of the image (e.g., invariant to size/scale) and/or identify features that are invariant to the rotation of the image (e.g., invariant to orientation). In some instances, upon extraction, these feature transformation features may be added to the database 114 as watch features data of the watch the face of which is captured in the analyzed image, i.e., the feature transformation features may be stored in the database 114 as unique visual fingerprints of the watch.

In some embodiments, the MTA 112 can be a module or application (e.g., software) on the CAS 108 executing a visual tracking algorithm configured to track the movement (e.g., change in position) of a feature across the multiple frames of a video showing that feature. For example, the MTA 112 may include a kernelized correlation filter (KCF) algorithm that can be applied to a video having multiple frames to track the relative displacements of a feature from one frame of the video to the next so as to visually track the movement of the feature in the video. For instance, as noted above, the IVC device 102a or the camera/video recorder 102b may capture a video of a face of a watch at a rate ranging from about 8,000 frames per second to about 16,000 frames per second, resulting in a large number of frames (i.e., still but consecutive images) of the face of the watch. In such cases, the MTA 112 may apply the visual tracking algorithm, such as but not limited to the KCF algorithm, to the video to track a feature of the face of the watch across the large number of consecutive frames of the video so as to delineate the movement of the feature.

For example, the video captured by the IVC device 102a or the camera/video recorder 102b and provided to the CAS 108 may include the face of a watch as a hand (e.g., second hand, minute hand, or hour hand) of the watch moves across the watch face. As a non-limiting illustrative example, the tip of the second hand can be the feature that is being tracked by the MTA 112. In such cases, the MTA 112 may identify other features surrounding the tip of the second hand and determine the movements of these features from one frame to the next. For example, the surrounding features can be other features surrounding the feature being tracked such that the latter is at least substantially at the center of the former. For example, the MTA 112 may identify a bounding box that encloses the feature-of-interest as well as the surrounding features in an initial frame of the video such that the feature-of-interest (e.g., the tip of the second hand) may be at least substantially at the center of the bounding box.

In some instances, the MTA 112 may track the movement of the feature-of-interest by tracking the movement or displacement (e.g., distance and change of direction), if any, of the position of the feature-of-interest from one frame to another. In some instances, the MTA 112 may track the movement of the feature-of-interest by tracking the displacement of the surrounding features. For example, the MTA 112 may track the displacement, if any, of the bounding box enclosing the feature-of-interest and the surrounding features, from one frame to another, and calculate the position of the center of the displaced bounding box, which may correspond to the position of the feature-of-interest.

In some instances, a motion curve of the feature-of-interest may be traced based on the movements of the feature-of-interest from one frame of the video to another, i.e., by tracking the positions of the feature-of-interest in the frames of the video captured by the IVC device 102a or the camera/video recorder 102b. For example, the MTA 112 may set a cartesian coordinate system for the face of the watch and the movement of the feature-of-interest across the frames of the video may be traced in the XY plane of the coordinate system by tracking the XY-coordinates (e.g., x_{f}, y_{f}) of the positions or locations of the feature-of-interest in the frames. With respect to the above non-limiting example where the feature-of-interest is the tip of a second hand of a watch, in some instances, the movement of the tip of the second hand across the frames of the video may be tracked by tracking the XY-coordinates of the position or location of the tip of the second hand on the XY plane. In such cases, the set of these XY-coordinates may represent or encode the motion of the tip of the second hand in the video. As another example, the XY-coordinates in the video frames of the center of a bounding box enclosing the additional features surrounding the tip of the second hand may be tracked, and the set of these XY-coordinates may be recorded as representations or encodings of the motion of the tip of the second hand in the video frames.

In some embodiments, the MTA 112 may be configured to analyze the set of XY-coordinates of a feature-of-interest to extract the motion curve of the feature-of-interest. For example, the MTA 112 may convert the set of XY-coordinates into a set of polar coordinates, and calculate therefrom the motion curve of the movement of the feature-of-interest. In some instances, an XY-coordinate (e.g., x_{f}, y_{f}) of a feature-of-interest in a cartesian coordinate system may be converted to a polar coordinate (e.g., r_{f}, θ_{f}) of the feature-of-interest, where r is the distance from a reference point (e.g., center) of the polar coordinate system to the feature-of-interest and θ_{f} is the angle from the reference point, using the equations (Equations 1):

$${r}_{f} = \sqrt{{x}_{f}^{2} + {y}_{f}^{2}} ; and$$

$${θ}_{f} = {tan}^{- 1} \frac{{y}_{f}}{{x}_{f}} .$$

In some instances, the polar coordinates (r_{f}, θ_{f}) of the positions of the feature-of-interest in the frames of the video may be used to trace the motion curve of the movement of the feature-of-interest, from which the MTA 112 may determine the physical properties of the mechanical system driving the watch hand including the feature of interest. With reference to the above example, the MTA 112 may extract the motion curve of the tip of the second hand as the second hand is moving across the watch face. In some instances, the motion of the second hand may include the second hand accelerating, overshooting, undershooting, ringing, etc., when ticking, and this motion may be represented by a motion curve derived from polar coordinates as discussed above. In some case, the unit of time for such a motion curve can be relative to the framerate the second hand is imaged and may be selected based on the speed of the second hand itself. Because the movements of the second hand such as but not limited to the acceleration, overshooting, undershooting, ringing, etc., are controlled or determined by the mechanical system of the watch driving the second hand, the motion curve can be used as a unique mechanical fingerprint of the watch. That is, the motion curve of a second hand of a watch may be stored in the database 114 as a watch features data of the watch. For example, the physical properties of the dampened oscillatory motion such as but not limited to the dampening constant, the duration of the oscillation, etc., may be stored in the database as the motion curve. It is to be understood that, although the discussion herein refers to the second hand of a watch, the discussion equally applies to other hands of the watch such as the hour hand or the minute hand.

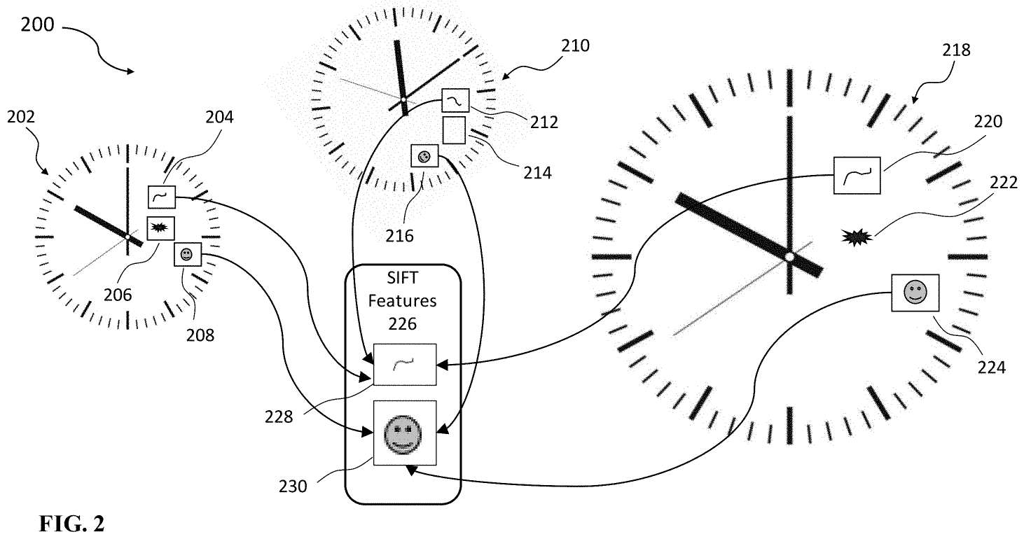

FIG. 2 is a schematic diagram 200 illustrating extraction of scale-invariant features of a face of a watch via a feature transform algorithm, according to various aspects of the present disclosure. In some embodiments, the image 202 of a face of a watch may be captured using a camera or an image capture device (e.g., the IVC device 102a or the camera/video recorder 102b in FIG. 1). In some instances, the image 202 may include one or more features 204, 206, 208, etc., of the watch located on the watch face under the watch crystal. In some cases, these one or more features 204, 206, 208, etc., can be candidates for use as feature transformation features of the watch face. For example, the one or more features 204, 206, 208, etc., may be features that are unique to the watch. Further, the one or more features 204, 206, 208, etc. may be resistant to wear and tear from normal use of the watch, and as such may remain on the face of the watch with little or no change over a long period of time (e.g., the lifetime of the watch). For instance, the one or more features 204, 206, 208, etc., can be stray marks, manufacturing defects/variations, etc., that are unique to the watch and likely to remain on the watch face with little or no material change (e.g., and as such can be candidates for use as feature transformation features of the watch).

In some embodiments, the one or more features 204, 206, 208, etc., may not qualify as feature transformation features unless the one or more features 204, 206, 208, etc., are invariant to one or more of size/scale, orientation, viewpoint, pose, illumination, etc. That is, for example, for a feature of a watch face to qualify as a feature transformation feature of the watch and be used as a unique visual fingerprint of the watch, the feature may have to be scale invariant, i.e., the feature may have associated therewith quantitative information, i.e., feature descriptors, that are invariant to changes in scale or size of the image. For example, the image with a candidate feature may be magnified, and the feature transformation feature descriptors of the candidate feature may be invariant to the magnification such that the feature descriptors may be used to identify in the magnified image the feature that corresponds to the candidate feature in the original (i.e., un-magnified) image. In some instances, the descriptors may be rotation invariant. For example, the image with a candidate feature may be rotated or its orientation changed otherwise, and the feature transformation feature descriptors of the candidate feature may be invariant to the rotation such that the descriptors may be used to identify in the rotated image the feature that corresponds to the candidate feature in the original (i.e., un-magnified) image. In some instances, the feature descriptors may also be invariant to viewpoint, pose, illumination, etc. That is, the viewpoint, pose and/or illumination in the image may be changed, and yet the feature transformation feature descriptors of the candidate feature may be invariant to these properties such that the feature descriptors may be used to identify in the changed image the feature that corresponds to the candidate feature in the original (i.e., un-magnified) image.

As a non-limiting illustrative example, FIG. 2 shows a rotated image 210 of the image 202 of a watch face and a magnified image 218 of the image 202. In some instances, the magnified image 218 may be magnified from about 300× to about 1000×, about 250× to about 750×, about 200× to about 500×, about 150× to about 350×, about 200× to about 250×, including values and subranges therebetween. In such cases, the one or more features 204, 206, 208, may be invariant with respect to the magnification and the descriptors of the one or more features 204, 206, 208 in the image 202 may be used to identify the corresponding features 220, 222, 224 in the magnified image 218. In some instances, the feature 206, however, may not be orientation-invariant, i.e., the descriptor of the feature 206 may not be used to identify a corresponding feature of the feature 206 in the rotated image 210 (e.g., indicated in FIG. 2 by the missing feature 214). In such cases, feature 206 may not considered to be a feature transformation feature of the watch having the watch face captured in the image 202. If the descriptors of features 204, 208 can be used, however, to identify in the rotated image 210 features 212, 216 that correspond to the features 204, 208 in the image 202, then features 204, 208 in the image 202 may be orientation invariant. In some instances, features 204, 208 may be invariant to scale, orientation, illumination, viewpoint, etc., (e.g., or changes thereof), and in such cases, features 204, 208 in image 202 may be feature transformation features 228, 230 of the set 226 of feature transformation features of the watch with the watch face that is captured in the image 202. It is to be understood that FIG. 2 is a non-limiting illustrative example and that features on the face of a watch under the watch crystal that are invariant to scale, orientation, illumination, viewpoint, etc., of the image of the watch face can be feature transformation features of the watch. In such cases, the feature transformation features of the watch may be stored in a database (e.g., such as database 114 in FIG. 1) associated with the watch to be used as the unique visual fingerprints of the watch.

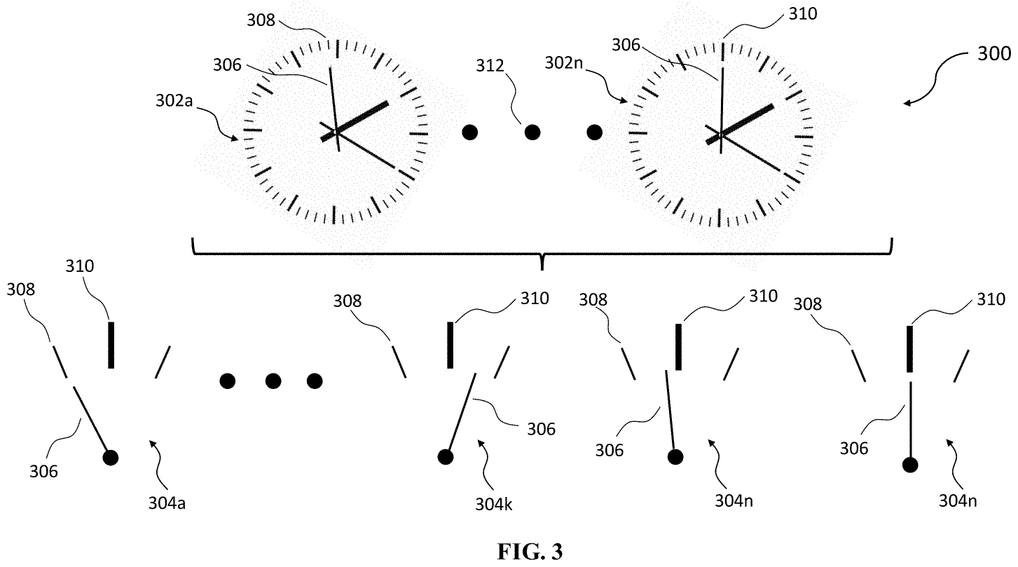

FIG. 3 is a schematic diagram 300 illustrating extraction of motion features of a face of a watch based on a video recording of the same, according to various aspects of the present disclosure. In some embodiments, the face of a watch may be video-recorded at a rate ranging from ranging from about 4,000 frames/second to about 16,000 frames/second, about 6,000 frames/second to about 14,000 frames/second, about 8,000 frames/second to about 12,000 frames/second, about 9,000 frames/second to about 11,000 frames/second, including values and subranges therebetween, as the second hand of the watch ticks a second (i.e., moves across the face of the watch to indicate the passage of a duration of a second). In some instances, although the discussion herein relates to the second hand, the same discussion may apply to the movement of the hour hand or the minute hand of the watch. That is, a high frame rate video of the face of the watch may be recorded as the hour hand, minute hand and/or second hand of the watch move across the face of the watch to indicate passage of time.

In some instances, the frames 302 of a video recording of the face of a watch may include a first frame 302a showing the second hand 306 of the watch aligning with a first time marker 308 of the watch and a second frame 302n showing the second hand 306 of the watch aligning with a second time marker 310 of the watch, indicating the passage of a second duration as the second hand 306 ticks or moves across the face of the watch from aligning with the first time marker 308 to aligning with the second time marker 310. In some instances, the frames 302 of the video may also include additional one or more frames 312 between the first frame 302a and the second frame 302n showing the positions of the second hand 306 during the ticking or movement of the second hand from aligning with the first time marker 308 to aligning with the second time marker 310. In some instances, these additional one or more frames 312 may show that the second hand 306 may not smoothly and uniformly progress from aligning with the first time marker 308 to aligning with the second time marker 310. Instead, in some instances, when moving from aligning with the first time marker 308 to aligning with the second time marker 310, the second hand 306 may perform a dampened oscillatory motion about the second time marker 310 before coming to rest aligned with the second time marker 310.

For example, in the first frame 304a of the video recording, the second hand 306 may be aligned with the first time marker 308. In a latter frame 304k of the video recording, however, the second hand 306 may be shown as having overshot the second time marker 310. In yet another latter frame 304n of the video recording, the second hand 306 may be shown as having undershot the second time marker 310. In some instances, the second hand 306 may overshot and undershot the second time marker 310 one or more times before coming to rest aligned with the second time marker 310 as shown in the frame 304n. That is, in some instances, the second hand 306 may perform a dampened oscillatory motion about the second time marker 310 by accelerating towards the second time marker 310, overshooting the second time marker 310, reversing the direction of its movement or ticking to undershoot the second time marker 310, and so on before coming to a stop aligned with the second time marker 310.

In some embodiments, the motion features of a watch may be extracted from the dampened oscillatory motion of the second hand, the minute hand, and/or the hour hand of the watch. In some instances, using the second hand as a non-limiting illustrative example, a point or a feature, i.e., a feature-of-interest, may be chosen from the second hand, and the motion curve of the feature-of-interest may be extracted from the frames 302a, . . . , 302n of the video recording of the second hand as the second hand moves across the watch face. For example, as discussed above, the dampened oscillatory motion of the tip of the second hand 306 may be traced. Then, by using the tip of the second hand 306 as the point-of-interest, in some instances, the motion curve of the movement of the feature-of-interest may be extracted from the dampened oscillatory motion (e.g., using polar coordinate system, as discussed above).

In some instances, because the dampened oscillatory motion of a hand of a watch is controlled by the mechanical system of the watch driving the movement or ticking of the hand, the motion curve derived from the dampened oscillatory motion may be unique to the watch. That is, the motion features of a watch that uniquely identify the watch may include the motion curve of the watch which may be used as a unique mechanical fingerprint of the watch. In such cases, the motion curve may be stored, as the motion features of the watch, in a database (e.g., such as database 114 in FIG. 1) associated with the watch.

In some embodiments, feature transformation features, motion features, and/or physical features or attributes of watches extracted or obtained as discussed above may be stored in a database configured to catalogue the provenance of watches. That is, the noted features of watches that have been proven to be authentic or genuine may be stored in a database as a catalogue of authenticated watches. For example, a watch provenance service provider or a watch manufacturer may confirm that a watch is authentic, extract the physical attributes/features, motion features and/or feature transformation features of the watch as discussed above, and catalogue the watch in the database by associating the features with each other so that a query for a physical attribute (e.g., serial number) of the watch allows one to locate the feature transformation features and/or motion features of that watch in the database. In some embodiments, one can use the catalogue of authentic watches to authenticate a candidate watch, i.e., determine whether the watch has been catalogued in the database as an authentic watch. For instance, a person wishing to purchase a watch (i.e., “candidate watch”) may consult the catalog after obtaining the physical features, feature transformation features, and/or motion features of the watch as discussed above and query the database to determine whether a watch with same or at least substantially similar features is catalogued in the database.

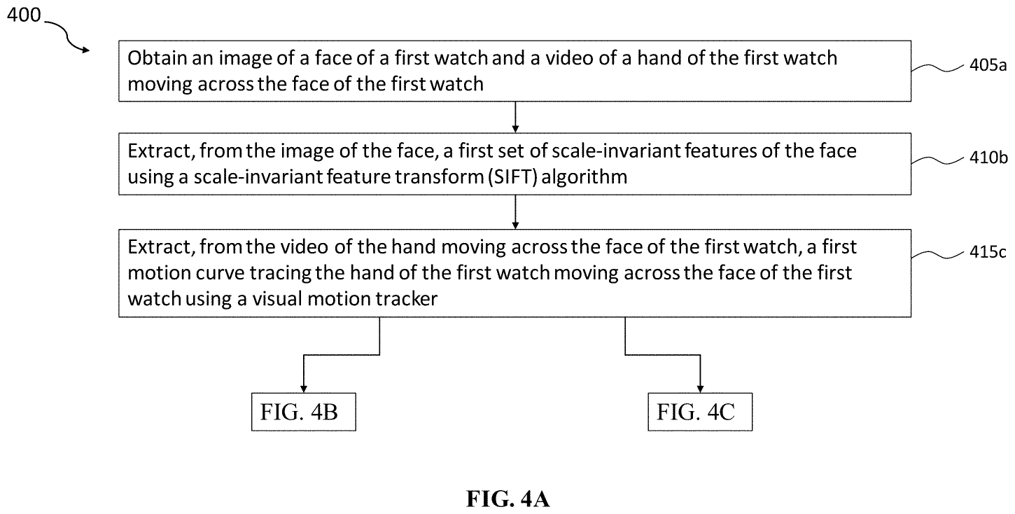

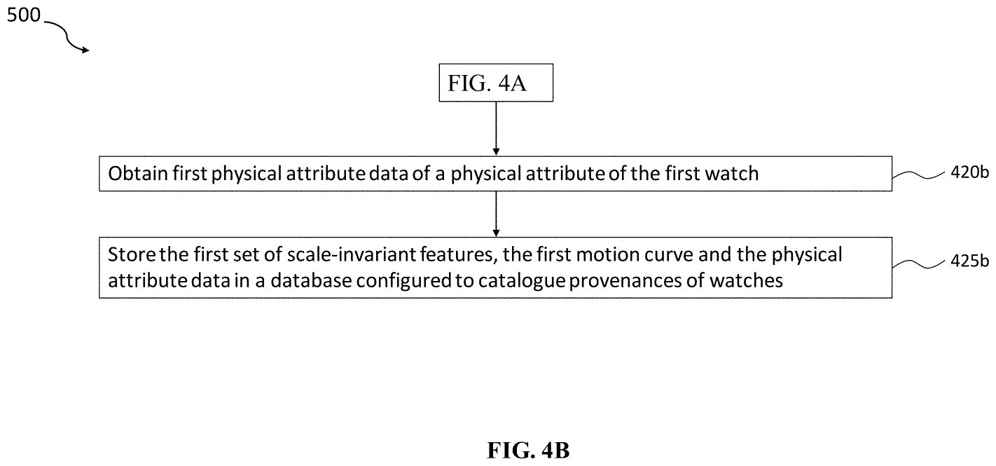

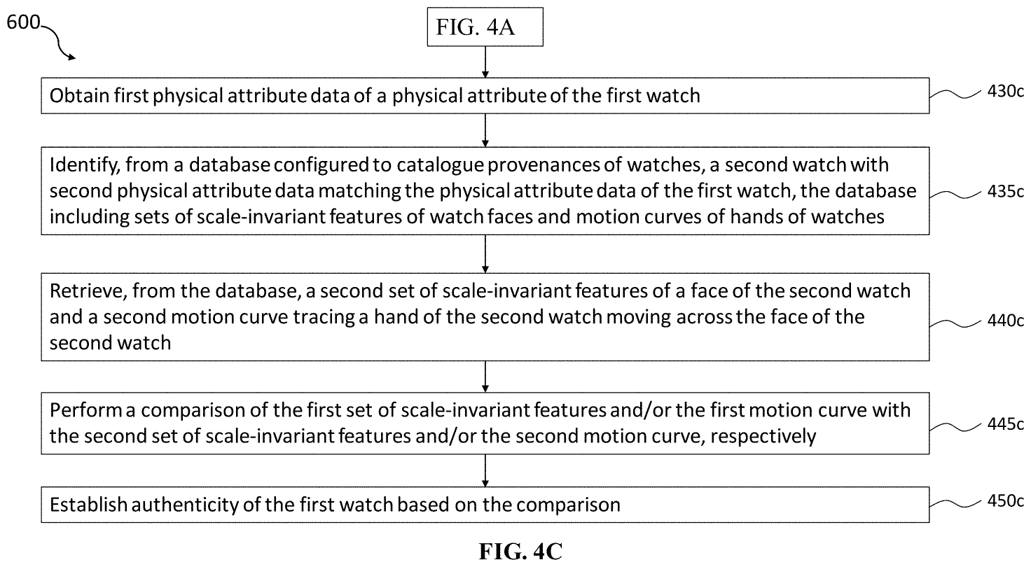

In some embodiments, FIGS. 4A and 4B in combination show flowcharts illustrating methods of extracting feature transformation features, motion features and physical features of a face of a watch to catalogue the watch in a database of authenticated watches, and FIGS. 4A and 4C in combination show flowcharts illustrating methods of extracting feature transformation features, motion features and physical features of a face of a watch and authenticating the provenance of the watch based on a comparison of the extracted features to those stored in database of authenticated watches, according to various aspects of the present disclosure. The various steps of methods 400, 500, and 600, which are described in greater detail above, may be performed by one or more electronic processors, for example by the processors of the CAS 108, and modules thereof (e.g., feature transformation extractor 110, MTA 112, etc.). In some embodiments, at least some of the steps of the method 400, 500, and 600 may be performed by the user device 104 and/or the IVC device 102a. Further, it is understood that additional method steps may be performed before, during, or after the steps 405a-415a, the steps 420b and 425b, and the steps 430c-450c. In addition, in some embodiments, one or more of the steps 405a-415a, the steps 420b and 425b, and the steps 430c-450c may also be omitted.

At block 405a of FIG. 4A, an image of a face of a first watch and a video of a hand of the first watch moving across the face of the first watch are obtained.

At block 410a, a first set of scale-invariant features of the face of the first watch may be extracted from the image of the face of the first watch using a feature transformation algorithm. That is, the feature transformation features of the first watch may be extracted from the image of the face of the first watch.

At block 415a, a first motion curve tracing the hand of the first watch moving across the face of the first watch may be extracted from the video of the face of the first watch using a visual motion tracker/analyzer. That is, the motion features of the first watch may be extracted from the video of a hand of the first watch moving across the face of the first watch.

In some embodiments, the first watch for which the feature transformation features and the motion features are extracted may be a watch that has been authenticated, and in such cases, a watch provenance service provider, a manufacturer of the watch, etc., may wish to include the first watch in a catalogue of authenticated watches. In such cases, at block 420b of FIG. 4B, the physical attribute data of the physical attributes or features of the first watch may be obtained.

At block 425b, the scale-invariant features, the motion curve and the physical attribute data may be stored in a database configured to catalogue provenances of watches. That is, the feature transformation features, the motion features and the physical features may be stored in the database associated with each other so that an entity querying the database to return one of the physical features may be able to locate the other features associated with the same watch. For instance, if one queries the database for a motion feature (e.g., motion curve) of a watch and locates the motion feature, the searcher may also be able to locate the feature transformation features and the physical features of the same watch associated with the motion features of the watch.

In some embodiments, the first watch for which the feature transformation features and the motion features are extracted may be a candidate watch that is being authenticated. That is, for example, one may be attempting to authenticate the first watch by determining whether the watch has been catalogued in the database of watch provenances as an authentic watch. In such cases, the candidate watch may be authenticated by comparing the feature transformation features, the motion features and/or the physical features with the respective feature transformation features, motion features and/or physical features of watches catalogued in the database, and determining whether there is a match.

With reference to FIG. 4C, at block 430c, the physical attribute data of the physical attributes or features of the first watch (i.e., “candidate watch”) may be obtained.

At block 435c, a second watch with second physical attribute data matching the physical attribute data of the first watch may be identified from the database configured to catalogue provenances of watches.

At block 440c, a second set of scale-invariant features of a face of the second watch and a second motion curve tracing a hand of the second watch moving across the face of the second watch may be retrieved from the database.

At block 445c, the first set of scale-invariant features and/or the first motion curve may be compared with the second set of scale-invariant features and/or the second motion curve, respectively.

At block 450c, the authenticity of the first watch may be established based on the comparison.

In some embodiments, as discussed above, to determine the authenticity of a candidate watch, the feature transformation features, the motion features and/or the physical features of the candidate watch may be obtained, and these features may be used to query the database of watch provenances to identify in the database matching feature transformation features, motion features and/or physical features. If there is a match, then the candidate watch may be identified as the authentic watch corresponding to the matched features in the database. In some instances, one or more of the feature transformation features, the motion features, or the physical features of the candidate watch may be used to query the database. For example, a physical feature (e.g., serial number, year of manufacture, etc.) of the candidate watch may be used to search or query the database of watch provenances, and a watch may be identified that has same or at least substantially similar physical feature as that of the candidate watch. As another example, a motion feature (e.g., motion curve) of the candidate match may be used to search or query the database of watch provenances to identify a watch that has same or at least substantially similar motion curve as that of the candidate watch. For instance, the damping constant of the candidate watch may be compared with the damping constants in the database of authentic watches to identify a watch, if any, that has a matching damping constant (e.g., within about 10%, about 5%, etc.). As yet another example, a feature transformation feature of the candidate match may be used to search or query the database of watch provenances to identify a watch that has the same or at least substantially similar feature transformation feature as that of the candidate watch.

In some instances, upon identifying a possible match for the candidate watch using one or more of a physical feature, a feature transformation feature, or a motion feature, the other features of the candidate watch may be compared with the corresponding features of the possible match. In some cases, a match score may be generated based on the comparison. For example, the physical features or attributes such as serial number, year of manufacture, color, model, band type, etc., of the candidate watch may be compared with the corresponding physical attributes of the possible match, and a physical attribute match score (e.g., percentage of the physical attributes that matched) may be generated based on the comparison. As another example, the motion curve of the candidate watch may be compared with the motion curve of the possible match. For instance, the damping constant, duration of dampened oscillation, etc., of the candidate match may be compared with the corresponding damping constant, duration of dampened oscillation, etc., of the possible match, and a motion features match score (e.g., percentage of the properties of motion curve that matched) may be generated based on the comparison. Further, in some instances, the feature transformation features of the candidate watch may be compared with the feature transformation features of the possible match watch, and a feature transformation match score (e.g., a percentage of the feature transformation features that are common to both the candidate watch and the possible match watch) may be generated. In some instances, the physical attribute match score, the motion feature match score, and/or the feature transformation feature match score may be combined to generate a match score that is configured to measure or quantify the level of matching between the candidate watch and the possible match watch. In some instances, the possible match watch may be considered to be a match for the candidate watch, and as such the candidate watch may be identified as an authentic watch the features of which are stored in the database, when the generated match score is equal to or greater than a threshold match score. Match scores below the threshold match score may indicate that the features of the candidate watch are not included in the database of watch provenances and that the candidate watch may not be an authentic watch. On the other hand, match scores equal to or greater than the threshold match score may indicate that the features of the candidate watch are included in the database, and as such the candidate watch is authenticated as a genuine watch.

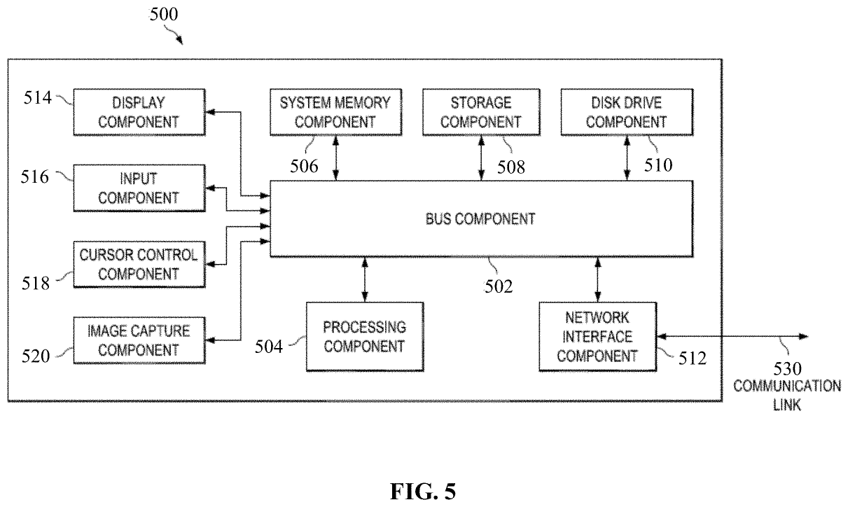

FIG. 5 is a block diagram of a computer system 500 suitable for implementing various methods and devices described herein, for example, the user device 104, the IVC device 102a, the CAS server 108, the feature transformation extractor 110, the MTA 112, and the database 112. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the aforementioned servers and modules, and the various method steps of the methods 400, 500 and 600 discussed below may be implemented as the computer system 500 in a manner as follows.

In accordance with various embodiments of the present disclosure, the computer system 500, such as a network server or a mobile communications device, includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure. In some embodiments, the various components of the feature transformation extractor 110 and the MTA 112 (e.g., the KCF-based motion tracker) may be in the form of software instructions that can be executed by the processor 504 to automatically perform context-appropriate tasks on behalf of a user.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the feature transformation extractor 110 and the MTA 112 discussed above.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by computer processor 504 as received and/or stored in disk drive component 510 or some other non-volatile storage component for execution. The communication link 530 and/or the communication interface 512 may be used to conduct electronic communications between the user device 104, the IVC device 102a, and the CAS server 108.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the feature transformation extractor 110 and the MTA 112 may be implemented as such software code.

### RECITATIONS OF SOME EMBODIMENTS OF THE PRESENT DISCLOSURE

Embodiment 1: A method, comprising: obtaining an image of a face of a first watch and a video of a hand of the first watch moving across the face of the first watch; extracting, from the image of the face, a first set of scale-invariant features of the face using a feature transformation algorithm; and extracting, from the video of the hand moving across the face of the first watch, a first motion curve tracing the hand of the first watch moving across the face of the first watch using a visual motion tracker.

Embodiment 2: The method of embodiment 1, wherein the image of the face is magnified at a magnification ranging from about 300 times to about 1,000 times.

Embodiment 3: The method of embodiment 1 or 2, wherein the hand is a second hand of the first watch.

Embodiment 4: The method of embodiment 3, wherein the video of the second hand moving across the face of the first watch is captured at a rate ranging from about 8,000 frames per second to about 16,000 frames per second.

Embodiment 5: The method of embodiment 3, wherein the first motion curve of the hand includes a dampening oscillation traced by a tip of the hand as the second hand is moving across the face of the first watch.

Embodiment 6: The method of any of embodiments 1-5, further comprising: obtaining physical attribute data of a physical attribute of the first watch; and storing the first set of scale-invariant features, the first motion curve and the physical attribute data in a database configured to catalogue provenances of watches.

Embodiment 7: The method of any of embodiments 1-6, further comprising: obtaining first physical attribute data of a physical attribute of the first watch; identifying, from a database configured to catalogue provenances of watches, a second watch with second physical attribute data matching the physical attribute data of the first watch, the database including sets of scale-invariant features of watch faces and motion curves of hands of watches; retrieving, from the database, a second set of scale-invariant features of a face of the second watch and a second motion curve tracing a hand of the second watch moving across the face of the second watch; performing a comparison of the first set of scale-invariant features and/or the first motion curve with the second set of scale-invariant features and/or the second motion curve, respectively; and establishing authenticity of the first watch based on the comparison.

Embodiment 8: The method of embodiment 6, wherein the physical attribute includes a serial number of the first watch, a model of the first watch, a manufacturer of the first watch, a color of the first watch, or a band type of the first watch.

Embodiment 9: The method of any of embodiments 1-8, wherein the visual motion tracker is a kernelized correlation filter (KCF)-based motion tracker.

Embodiment 10: A system, comprising: a camera configured to capture an image of a face of a first watch; a scale-invariant feature extractor configured to receive the image from the camera and extract from the image a first set of scale-invariant features of the face; a video recorder configured to capture a video of a hand of the first watch moving across the face of the first watch; and a visual motion tracker configured to receive the video from the video recorder and extract from the video a first motion curve tracing the hand of the first watch moving across the face of the first watch.

Embodiment 11: The system of embodiment 10, further comprising: a non-transitory memory storing instructions; a processor configured to execute the instructions to cause the system to: receive a request to establish provenance of the first watch; obtain first physical attribute data of a physical attribute of the first watch; identify, from a database configured to catalogue provenances of watches, a second watch with second physical attribute data matching the physical attribute data of the first watch; retrieve, from the database, a second set of scale-invariant features of a face of the second watch and a second motion curve tracing a hand of the second watch moving across the face of the second watch; perform a comparison of the first set of scale-invariant features and/or the first motion curve with the second set of scale-invariant features and/or the second motion curve, respectively; and establish the provenance of the first watch based on the comparison.

Embodiment 12: The system of embodiment 10 or 11, wherein the scale-invariant feature extractor is a feature transformation (extractor executing a feature transformation algorithm.

Embodiment 13: The system of any of embodiments 10-12, wherein the visual motion tracker is a kernelized correlation filter (KCF)-based motion tracker.

Embodiment 14: The system of any of embodiments 10-12, wherein the camera is configured to capture the image of the face at a magnification ranging from about 300 times to about 1,000 times.

Embodiment 15: The system of any of embodiments 10-13, wherein the hand is a second hand of the first watch; and the video recorder is configured to capture the video of the second hand moving across the face of the first watch at a rate ranging from about 8,000 frames per second to about 16,000 frames per second.

Embodiment 16: A non-transitory computer-readable medium (CRM) having stored thereon computer-readable instructions executable to cause a computer to perform operations comprising: extracting, from an image of a face of a first watch, a first set of scale-invariant features of the face using a feature transformation algorithm; extracting, from a video of a hand of the first watch moving across the face of the first watch, a first motion curve tracing the hand of the first watch moving across the face of the first watch using a kernelized correlation filter (KFC); obtaining first physical attribute data of a physical attribute of the first watch; identifying, from a database configured to catalogue provenances of watches, a second watch with second physical attribute data matching the physical attribute data of the first watch; retrieving, from the database, a second set of scale-invariant features of a face of the second watch and a second motion curve tracing a hand of the second watch moving across the face of the second watch; performing a comparison of the first set of scale-invariant features and/or the first motion curve with the second set of scale-invariant features and/or the second motion curve, respectively; and establishing authenticity of the first watch based on the comparison.

Embodiment 17: The non-transitory CRM of embodiment 16, wherein the image of the face is magnified at a magnification ranging from about 300 times to about 1,000 times.

Embodiment 18: The non-transitory CRM of embodiment 16 or 17, wherein the hand is a second hand of the first watch; and the video of the second hand moving across the face of the first watch is captured at a rate ranging from about 8,000 frames per second to about 16,000 frames per second.

Embodiment 19: The non-transitory CRM of any of embodiments 16-18, wherein the physical attribute of the first watch includes a serial number of the first watch, a model of the first watch, a manufacturer of the first watch, a color of the first watch, or a band type of the first watch.

Embodiment 20: The non-transitory CRM of any of embodiments 16-19, wherein the first motion curve of the hand includes a dampening oscillation traced by a tip of the hand as the second hand is moving across the face of the first watch.

A reference to an element in the singular is not intended to mean “one and only one” unless specifically stated, but rather “one or more.” As used herein, the term “about” used with respect to numerical values or parameters or characteristics that can be expressed as numerical values means within ten percent of the numerical values. For example, “about 50” means a value in the range from 45 to 55, inclusive.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
obtaining an image of a face of a first watch and a video of a hand of the first watch moving across the face of the first watch;
extracting, from the image of the face, a first set of scale-invariant features of the face using a feature transformation algorithm; and
extracting, from the video of the hand moving across the face of the first watch, a first motion curve tracing the hand of the first watch moving across the face of the first watch using a visual motion tracker.

2. The method of claim 1, wherein the image of the face is magnified at a magnification ranging from about 300 times to about 1,000 times.

3. The method of claim 1, wherein the hand is a second hand of the first watch.

4. The method of claim 3, wherein the video of the second hand moving across the face of the first watch is captured at a rate ranging from about 8,000 frames per second to about 16,000 frames per second.

5. The method of claim 3, wherein the first motion curve of the hand includes a dampening oscillation traced by a tip of the hand as the second hand is moving across the face of the first watch.

6. The method of claim 1, further comprising:
obtaining physical attribute data of a physical attribute of the first watch; and
storing the first set of scale-invariant features, the first motion curve and the physical attribute data in a database configured to catalogue provenances of watches.

7. The method of claim 1, further comprising:
obtaining first physical attribute data of a physical attribute of the first watch;
identifying, from a database configured to catalogue provenances of watches, a second watch with second physical attribute data matching the physical attribute data of the first watch, the database including sets of scale-invariant features of watch faces and motion curves of hands of watches;
retrieving, from the database, a second set of scale-invariant features of a face of the second watch and a second motion curve tracing a hand of the second watch moving across the face of the second watch;
performing a comparison of the first set of scale-invariant features and/or the first motion curve with the second set of scale-invariant features and/or the second motion curve, respectively; and
establishing authenticity of the first watch based on the comparison.

8. The method of claim 6, wherein the physical attribute includes a serial number of the first watch, a model of the first watch, a manufacturer of the first watch, a color of the first watch, or a band type of the first watch.

9. The method of claim 1, wherein the visual motion tracker is a kernelized correlation filter (KCF)-based motion tracker.

10. A system, comprising:
a camera configured to capture an image of a face of a first watch;
a feature extractor configured to receive the image from the camera and extract from the image a first set of scale-invariant features of the face;
a video recorder configured to capture a video of a hand of the first watch moving across the face of the first watch; and
a visual motion tracker configured to receive the video from the video recorder and extract from the video a first motion curve tracing the hand of the first watch moving across the face of the first watch.

11. The system of claim 10, further comprising:
a non-transitory memory storing instructions;
a processor configured to execute the instructions to cause the system to:
receive a request to establish provenance of the first watch;
obtain first physical attribute data of a physical attribute of the first watch;
identify, from a database configured to catalogue provenances of watches, a second watch with second physical attribute data matching the physical attribute data of the first watch;
retrieve, from the database, a second set of scale-invariant features of a face of the second watch and a second motion curve tracing a hand of the second watch moving across the face of the second watch;
perform a comparison of the first set of scale-invariant features and/or the first motion curve with the second set of scale-invariant features and/or the second motion curve, respectively; and
establish the provenance of the first watch based on the comparison.

12. The system of claim 10, wherein the feature extractor is a feature transformation extractor executing a feature transformation algorithm.

13. The system of claim 10, wherein the visual motion tracker is a kernelized correlation filter (KCF)-based motion tracker.

14. The system of claim 10, wherein the camera is configured to capture the image of the face at a magnification ranging from about 300 times to about 1,000 times.

15. The system of claim 10, wherein:
the hand is a second hand of the first watch; and
the video recorder is configured to capture the video of the second hand moving across the face of the first watch at a rate ranging from about 8,000 frames per second to about 16,000 frames per second.

16. A non-transitory computer-readable medium (CRM) having stored thereon computer-readable instructions executable to cause a computer to perform operations comprising:
extracting, from an image of a face of a first watch, a first set of scale-invariant features of the face using a feature transformation algorithm;
extracting, from a video of a hand of the first watch moving across the face of the first watch, a first motion curve tracing the hand of the first watch moving across the face of the first watch using a kernelized correlation filter (KFC);
obtaining first physical attribute data of a physical attribute of the first watch;
identifying, from a database configured to catalogue provenances of watches, a second watch with second physical attribute data matching the physical attribute data of the first watch;
retrieving, from the database, a second set of scale-invariant features of a face of the second watch and a second motion curve tracing a hand of the second watch moving across the face of the second watch;
performing a comparison of the first set of scale-invariant features and/or the first motion curve with the second set of scale-invariant features and/or the second motion curve, respectively; and
establishing authenticity of the first watch based on the comparison.

17. The non-transitory CRM of claim 16, wherein the image of the face is magnified at a magnification ranging from about 300 times to about 1,000 times.

18. The non-transitory CRM of claim 16, wherein
the hand is a second hand of the first watch; and
the video of the second hand moving across the face of the first watch is captured at a rate ranging from about 8,000 frames per second to about 16,000 frames per second.

19. The non-transitory CRM of claim 16, wherein the physical attribute of the first watch includes a serial number of the first watch, a model of the first watch, a manufacturer of the first watch, a color of the first watch, or a band type of the first watch.

20. The non-transitory CRM of claim 16, wherein the first motion curve of the hand includes a dampening oscillation traced by a tip of the hand as the second hand is moving across the face of the first watch.
